(19) United States
(12) Patent Application Publication
(10) Pub. No.: US 2026/0350229 A1
(43) Pub. Date: Nov. 5, 2026

(54) Bitcoin-Anchor Authentication System with Spend-Triggered Revocation and Optional Hierarchical Delegation

(71) Applicants: Crystal Smith, Bellevue, WA (US); Alejandro Patino, Bellevue, WA (US); Armando Patino, Phoenix, AZ (US)

(72) Inventors: Crystal Smith, Bellevue, WA (US); Alejandro Patino, Bellevue, WA (US); Armando Patino, Phoenix, AZ (US)

(21) Appl. No.: 19/664,559

(22) Filed: Apr. 30, 2026

Related U.S. Application Data
(60) Provisional application No. 63/797,833, filed on Apr. 30, 2025.

(51) Int. Cl. G06F 21/62; H04L 9/08; H04L 9/30; H04L 9/32

(52) U.S. Cl. CPC G06F 21/629; H04L 9/0825; H04L 9/0891; H04L 9/30; H04L 9/3252; H04L 9/3271; G06F 2221/2141

(57) ABSTRACT

A computer-implemented method, system, and non-transitory computer-readable medium for authentication and access control. A verifier generates a challenge message and receives a digital signature over the challenge message from an entity. The verifier recovers a Bitcoin public key and a corresponding Bitcoin address mathematically from the digital signature without the Bitcoin public key having been transmitted by the entity. The verifier determines an authentication anchor associated with the entity, the authentication anchor comprising a Bitcoin address or locking script or a designated unspent transaction output, and queries Bitcoin blockchain data to determine whether a revocation condition associated with the authentication anchor has occurred. Access is authorized only when the digital signature is valid and the authentication anchor is unrevoked. Embodiments include hierarchical delegation, multi-signature anchors, continuous session monitoring, and registry-based identification.

### CROSS-REFERENCE TO RELATED APPLICATIONS

This application claims the benefit of priority to U.S. Provisional Patent Application No. 63/797,833, filed Apr. 30, 2025, entitled “Bitcoin-Based Sovereign Identity Authentication System with Self-Revoking Access,” the entire contents of which are incorporated herein by reference.

### FIELD OF INVENTION

The present invention relates to authentication and access control systems, and more particularly to passwordless authentication methods and systems that combine cryptographic signing with publicly verifiable distributed ledger transaction state to determine whether access to a protected resource should be granted, denied, or revoked.

### BACKGROUND

Authentication systems have long relied on shared secrets—passwords, security questions, recovery emails, and phone-bound second factors—to establish that a party requesting access is the party entitled to it. Each of these mechanisms places sensitive credential material under the control of one or more centralized custodians, including identity providers, password managers, mobile carriers, and cloud-based authenticator services. The custodial nature of such credentials creates well-documented vulnerabilities. Passwords are routinely compromised through phishing, database breach, and reuse across services. Phone-based second factors are vulnerable to SIM swap attacks and to operational errors by mobile carrier staff. Account recovery workflows, which are designed to restore access when primary credentials are lost, frequently introduce a weaker authentication path that attackers exploit through social engineering. Even when underlying cryptographic primitives are sound, the reliance on a custodian to bind credential material to identity introduces a dependency that has repeatedly failed in practice.

Public-key cryptography offers a structural alternative in which a holder retains the private key and a verifier checks signatures against a corresponding public key. Hardware security modules, smart cards, and FIDO/WebAuthn authenticators have applied this principle to user authentication and have substantially improved security where they are deployed. However, public-key authentication standing alone provides no inherent revocation mechanism. Once a key has been compromised or once the holder of a key is no longer entitled to access a particular resource, the verifier requires a separate channel through which to learn that the key should no longer be honored. In conventional public-key infrastructure, that channel is provided by certificate revocation lists, the Online Certificate Status Protocol, or analogous published statements from a certificate authority. Each such mechanism reintroduces a centralized administrative actor whose continued cooperation is required for the revocation to be observed and enforced. The practical consequence is that revocation in public-key systems is at best as reliable as the operational health and integrity of the issuing authority, and is typically slower and less universally distributed than the original credential issuance.

Several categories of approach have proposed to use distributed ledgers—and in particular blockchains—as an alternative substrate for identity and credential management. One category writes purpose-created attestation transactions onto a public blockchain, with each attestation associating identifying information with a public key. In such approaches, a trusted third-party attestor is typically responsible for issuing the attestation, and revocation is performed by the attestor (or by a coordinating authority) through a further on-chain transaction that invalidates the attestation. While this category eliminates the need for a single centralized credential database, it does not eliminate the need for a trusted third party; rather, it relocates trust from the database operator to the attestor and to the chain on which the attestations are written. A further category links X.509 digital certificates issued by a certificate authority to blockchain transaction outputs, with the unspent state of the output serving as a token of validity. While this category combines public-key infrastructure with on-chain state, it depends on a chain of certificate authority signatures and on the certificate authority's continuing operation in order for the credentials to be created and recognized.

A further category of approach has proposed signature-based passwordless login protocols using Bitcoin or Lightning Network keys. In such protocols, a holder signs a challenge message with a key derived deterministically from a wallet seed, and the verifier confirms the signature. While this category dispenses with shared secrets and eliminates several password-related attack vectors, the protocols specified to date do not consult any blockchain state during verification and provide no revocation mechanism beyond the holder's discretion not to sign. As a consequence, a key that has been compromised remains capable of producing valid signatures until the holder manually rotates to a new key and registers the new key with each verifier. There is no automatic, blockchain-enforced revocation of a compromised credential, and there is no irreversible signal that a verifier can observe to determine that a previously authorized credential should no longer be honored.

The foregoing approaches, considered separately and in combination, leave open a substantial unmet need in the art. Practitioners require an authentication and access control mechanism that provides cryptographic strength comparable to or better than existing public-key authentication; that requires no trusted third party, no certificate authority, no centralized identity provider, and no off-chain administrative communication channel for revocation; that derives revocation status from publicly verifiable, immutable machine state rather than from a published statement of any administrative actor; that supports irreversible, holder-controlled revocation accomplished through a single on-chain action; and that supports hierarchical delegation in which authority granted to subordinate credentials, including to autonomous software agents, is automatically and simultaneously withdrawn when the principal entity revokes the master credential. It is in this context that the present invention is provided.

### SUMMARY

According to a first aspect of the present invention, there is provided a computer-implemented method for authenticating and controlling access. The method is performed by one or more processors of a verifier and comprises generating a challenge message; receiving a digital signature over the challenge message from an entity; recovering a Bitcoin public key and a corresponding Bitcoin address from the digital signature without the Bitcoin public key having been transmitted by the entity; determining an authentication anchor associated with the entity, the authentication anchor comprising at least one of a Bitcoin address or locking script and a designated unspent transaction output identified by a transaction identifier and an output index; determining, using Bitcoin blockchain data, whether a revocation condition associated with the authentication anchor has occurred; and authorizing access when the Bitcoin public key and the corresponding Bitcoin address are successfully recovered from the digital signature and the revocation condition has not occurred.

In some embodiments, the authentication anchor comprises a Bitcoin address or locking script, and the revocation condition comprises detection of a spend event associated with the Bitcoin address or locking script, wherein a spend event associated with a Bitcoin address or locking script means a transaction that spends an output having a locking script corresponding to that address or locking script.

In some embodiments, the authentication anchor is a Bitcoin address having zero outgoing spend transactions recorded on the Bitcoin blockchain, and the revocation condition is triggered by any outgoing spend transaction associated with said address.

In some embodiments, the authentication anchor comprises a designated unspent transaction output identified by a transaction identifier and an output index, and the revocation condition comprises the designated unspent transaction output being spent.

In some embodiments, the challenge message comprises at least one of a timestamp, a nonce, an expiration value, a relying-party identifier, and a context value, and authorizing access further comprises enforcing a freshness requirement based on the challenge message.

In some embodiments, the method further comprises associating the challenge message with an entity identifier and verifying that the digital signature was produced by a signing key associated with the entity identifier.

In some embodiments, authorizing access comprises authorizing at least one action, operation, or use of a resource, the resource comprising at least one of an application, an account, a system, a network, a device, an encrypted data store, a digital service, a lock, a safe, a vehicle ignition, a door, a secured enclosure, and a secured environment.

In some embodiments, the method further comprises transitioning from a first authentication anchor to a second authentication anchor based on a signed transition statement linking the first authentication anchor to the second authentication anchor and produced prior to a revocation condition associated with the first authentication anchor.

In some embodiments, the method further comprises delegated authorization, in which a master authentication anchor authorizes one or more subordinate credentials, authorization of access for a subordinate credential depends on the master authentication anchor not being revoked, and revocation of the master authentication anchor causes simultaneous denial of access for all subordinate credentials authorized by the master authentication anchor.

In some embodiments, the method further comprises maintaining, by the entity, a plurality of authentication anchors simultaneously, each authentication anchor of the plurality being independently associated with a distinct service, account, or resource, such that the revocation condition occurring for one authentication anchor of the plurality does not affect the revocation status of any other authentication anchor of the plurality.

In some embodiments, the authentication anchor comprises a multi-signature locking script requiring a threshold number of valid digital signatures from distinct Bitcoin private keys to authorize access, and authorizing access further comprises receiving and verifying the threshold number of valid digital signatures over the challenge message.

In some embodiments, the digital signature comprises at least one of (i) a Bitcoin Signed Message under BIP-137 or BIP-322 from which the Bitcoin public key is recovered by an elliptic curve digital signature algorithm public-key recovery operation over the secp256k1 curve, and (ii) a Schnorr signature under BIP-340 corresponding to a Taproot output address.

In some embodiments, the verifier holds no private key associated with the entity, and the verifier authenticates the entity using only public information comprising the digital signature, the challenge message, and Bitcoin blockchain data.

In some embodiments, the entity comprises an autonomous software agent including a large language model based agent, and the master authentication anchor authorizing the autonomous software agent is held by a principal entity distinct from the autonomous software agent.

In some embodiments, the method further comprises periodically re-determining, during an active session established upon authorization, whether the revocation condition associated with the authentication anchor has occurred, and terminating the active session upon detecting that the revocation condition has occurred.

In some embodiments, the digital signature is received from the entity without an entity identifier or authentication anchor identifier being transmitted by the entity, the verifier determines the authentication anchor by querying a registry of registered Bitcoin addresses against the recovered Bitcoin address, and access is denied when no matching registered Bitcoin address is found in the registry.

In some embodiments, the method further comprises, prior to receiving the digital signature, signing the challenge message by the verifier using a verifier Bitcoin private key associated with a verifier authentication anchor, transmitting the signed challenge message to the entity, and the entity verifies a verifier digital signature over the challenge message and determines from Bitcoin blockchain data that the verifier authentication anchor is unrevoked before generating the digital signature.

In some embodiments, the method further comprises pre-registering, by the entity, one or more recovery anchors at account creation, each recovery anchor comprising a Bitcoin address, a locking script, or a designated unspent transaction output separate from a primary authentication anchor, and authorizing, in response to a signed recovery request from one of the recovery anchors, a transition from the primary authentication anchor to a new authentication anchor.

According to a second aspect of the present invention, there is provided a system for authenticating and controlling access. The system comprises one or more processors and one or more non-transitory computer-readable media storing instructions that, when executed by the one or more processors, cause the system to perform operations comprising generating a challenge message; receiving a digital signature over the challenge message from an entity; recovering a Bitcoin public key and a corresponding Bitcoin address from the digital signature without the Bitcoin public key having been transmitted by the entity; determining an authentication anchor associated with the entity, the authentication anchor comprising at least one of a Bitcoin address or locking script and a designated unspent transaction output identified by a transaction identifier and an output index; determining, using Bitcoin blockchain data, whether a revocation condition associated with the authentication anchor has occurred; and authorizing access when the Bitcoin public key and the corresponding Bitcoin address are successfully recovered from the digital signature and the revocation condition has not occurred.

According to a third aspect of the present invention, there is provided a non-transitory computer-readable medium storing instructions that, when executed by one or more processors, cause the one or more processors to perform operations comprising the operations recited in the first aspect.

According to a fourth aspect of the present invention, there is provided a computer-implemented method for proving identity to an authentication system, the method being performed by one or more processors of an entity and comprising generating a digital signature over a challenge message using a Bitcoin private key, wherein the Bitcoin private key corresponds to a Bitcoin public key associated with a Bitcoin address or locking script; transmitting the digital signature to a verifier without transmitting the Bitcoin public key; and receiving an authorization decision from the verifier based on recovery of the Bitcoin public key and a corresponding Bitcoin address from the digital signature and an unrevoked condition of an authentication anchor associated with the entity as determined from Bitcoin blockchain data.

### BRIEF DESCRIPTION OF THE DRAWINGS

Various embodiments of the invention are disclosed in the following detailed description and accompanying drawings.

FIG. 1 illustrates an example flow diagram of an authentication and access control method performed by a verifier and including continuous session monitoring, in accordance with an embodiment of the present invention.

FIG. 2 illustrates an example diagram of two authentication anchor modes, comprising an address or locking script anchor mode and a designated unspent transaction output anchor mode, in accordance with an embodiment of the present invention.

FIG. 3 illustrates an example diagram of a hierarchical delegation and revocation embodiment in which a master authentication anchor authorizes a plurality of subordinate credentials and a single on-chain spend event affecting the master authentication anchor causes simultaneous revocation of all subordinate credentials, in accordance with an embodiment of the present invention.

Common reference numerals are used throughout the figures and the detailed description to indicate like elements. One skilled in the art will readily recognize that the above figures are examples and that other architectures, modes of operation, orders of operation, and elements/functions can be provided and implemented without departing from the characteristics and features of the invention as set forth in the appended claims.

### DETAILED DESCRIPTION AND PREFERRED EMBODIMENT

The following is a detailed description of exemplary embodiments to illustrate the principles of the invention. The embodiments are provided to illustrate aspects of the invention, but the invention is not limited to any embodiment. The scope of the invention encompasses numerous alternatives, modifications, and equivalents; it is limited only by the claims.

Numerous specific details are set forth in the following description in order to provide a thorough understanding of the invention. However, the invention may be practiced according to the claims without some or all of these specific details. For the purpose of clarity, technical material that is known in the technical fields related to the invention has not been described in detail so that the invention is not unnecessarily obscured. It will be understood that structural, logical, and electrical changes may be made without departing from the scope of the invention as defined by the appended claims.

### Definitions

The terminology used herein is for the purpose of describing particular embodiments only and is not intended to be limiting of the invention.

As used herein, the term “and/or” includes any and all combinations of one or more of the associated listed items.

The terms “comprises,” “comprising,” “includes,” and “including,” when used in this specification, specify the presence of stated features, steps, operations, elements, and/or components, but do not preclude the presence or addition of one or more other features, steps, operations, elements, components, and/or groups thereof.

The term “Bitcoin blockchain” refers to a public distributed ledger that records, in a sequence of cryptographically linked blocks, transactions denominated in a unit of value associated with the ledger and verifiable through proof-of-work or an analogous consensus mechanism. As used herein, the term “Bitcoin blockchain” includes, without limitation, the public Bitcoin blockchain commonly identified by ticker symbol BTC, and may further include any successor protocol, fork, or compatible network supporting the cryptographic primitives and transaction structures described herein. Where the present invention refers to “Bitcoin blockchain data,” such data may be obtained from a node directly participating in the network, from an indexing service, from a public block explorer, or from any other source providing a faithful representation of the ledger state.

The term “public distributed ledger” refers to any cryptographically secured, append-only data structure that records transactions or state transitions and is publicly readable by parties not participating in its operation. The Bitcoin blockchain is a preferred example of a public distributed ledger for the purposes of the present invention; alternative public distributed ledgers may also be used in alternative embodiments where supported by appropriate cryptographic primitives.

The term “Bitcoin private key” refers to a numerical value, typically a 256-bit integer in a defined range, that serves as the secret element of an asymmetric key pair on the secp256k1 elliptic curve, and from which a corresponding Bitcoin public key is mathematically derivable. The term “Bitcoin public key” refers to the corresponding public element of such a key pair, expressed as a point on the secp256k1 curve.

The term “Bitcoin address” refers to an alphanumeric identifier derived from a Bitcoin public key or from a locking script and used to receive value in transactions on the Bitcoin blockchain. Bitcoin addresses include, without limitation, pay-to-public-key-hash addresses, pay-to-script-hash addresses, and SegWit and Taproot addresses encoded in bech32 or bech32m formats.

The term “locking script” refers to a script associated with an output of a Bitcoin transaction and specifying conditions that must be satisfied in order to spend the output. A locking script may, without limitation, require one or more digital signatures from one or more Bitcoin private keys, may require satisfaction of one or more time-based or hash-based conditions, or may comprise any other valid combination of script primitives supported by the Bitcoin protocol.

The term “unspent transaction output” or “UTXO” refers to an output of a Bitcoin transaction that has not yet been consumed as an input to a subsequent Bitcoin transaction. A UTXO is identified by the transaction identifier of the transaction that created it and by the output index of the output within that transaction.

The term “spend event,” when used in connection with a Bitcoin address or locking script, refers to a transaction recorded on the Bitcoin blockchain that consumes as one of its inputs an output having a locking script corresponding to the Bitcoin address or locking script. When used in connection with a designated unspent transaction output, the term “spend event” refers to a transaction recorded on the Bitcoin blockchain that consumes the designated unspent transaction output as one of its inputs.

The term “digital signature” refers to a value computed by applying a Bitcoin private key to a message under a defined signature scheme, where the signature scheme includes, without limitation, the Elliptic Curve Digital Signature Algorithm (ECDSA) over the secp256k1 curve and the Schnorr signature scheme defined under BIP-340. The term “Bitcoin Signed Message” refers to a digital signature produced in accordance with the message signing format defined under BIP-137 or BIP-322 or any successor or compatible format from which a Bitcoin public key and a corresponding Bitcoin address may be recovered.

The term “challenge message” refers to a message generated by a verifier and provided to an entity for the purpose of producing a digital signature over the challenge message. A challenge message may comprise, without limitation, one or more of a timestamp, a nonce, an expiration value, a relying-party identifier, an action identifier, a client identifier, and a context value.

The term “authentication anchor” refers to a piece of state on the Bitcoin blockchain whose unrevoked status determines, in part or in whole, whether an entity associated with the authentication anchor is authorized to access a resource. An authentication anchor comprises at least one of a Bitcoin address, a locking script, and a designated unspent transaction output identified by a transaction identifier and an output index.

The term “revocation condition” refers to a condition determinable from Bitcoin blockchain data, the occurrence of which causes an authentication anchor to be treated as revoked for purposes of authorization. For an authentication anchor comprising a Bitcoin address or locking script, the revocation condition is the detection of a spend event associated with the Bitcoin address or locking script. For an authentication anchor comprising a designated unspent transaction output, the revocation condition is the spending of the designated unspent transaction output.

The term “verifier” refers to a computer system, server, embedded processor, or any other computing device that performs the authentication and authorization operations described herein. A verifier may comprise one or more processors and one or more memories storing instructions, and may communicate with a Bitcoin node, an indexing service, a block explorer, or any other source of Bitcoin blockchain data, and with an entity over a communication channel.

The term “entity” refers to any party seeking access to a resource through the authentication and authorization operations described herein. An entity includes, without limitation, a human user operating a computing device, a software process, a service, an autonomous software agent, a large language model based agent, a hardware device, or any combination thereof.

The term “processor” refers to any electronic circuit or combination of circuits capable of executing instructions and performing computational operations. This includes, without limitation, central processing units, graphics processing units, tensor processing units, field-programmable gate arrays, application-specific integrated circuits, digital signal processors, and any combination thereof. A processor may be physically co-located in a single device or distributed across multiple devices in communication with one another.

The term “memory” refers to any computer-readable storage medium capable of storing data and instructions accessible by a processor. This includes, without limitation, random access memory, read-only memory, flash memory, solid-state drives, hard disk drives, optical storage media, magnetic tape storage, and any combination thereof. The term “non-transitory computer-readable medium” excludes transitory propagating signals per se, but otherwise includes any of the foregoing forms of memory.

Unless expressly stated otherwise, words such as “a,” “an,” and “the” are intended to include both singular and plural forms, and recitation of a range inherently includes all sub-ranges and individual values within that range. All exemplary parameters, intervals, and dimensions may be interchanged with other functionally equivalent values without departing from the scope of the invention.

### Description of Drawings

The present invention provides an authentication and access control mechanism in which authority to access a resource is conditioned both on cryptographic proof of control of a Bitcoin private key and on the unrevoked status of an authentication anchor as determined from Bitcoin blockchain data. Three actors participate in the operation of the invention. A verifier is a computer system that requires authentication of an entity prior to granting access to a protected resource. An entity is a party—including without limitation a human user, a software process, a service, a hardware device, or an autonomous software agent—that seeks access to the protected resource. The Bitcoin blockchain is a public distributed ledger that records transactions and that is queryable by the verifier in order to determine the revocation status of an authentication anchor. The verifier holds no private key associated with the entity and stores no shared secret recoverable by either party in isolation; the entity holds the Bitcoin private key associated with its authentication anchor; and the Bitcoin blockchain holds the publicly verifiable transaction state from which the verifier determines whether the authentication anchor has been revoked. The architecture is therefore stateless on the part of the verifier with respect to recoverable credential material, requires no trusted third party to issue, manage, or revoke credentials, and provides irreversible, holder-controlled revocation accomplished through a single on-chain action.

The verifier and the entity communicate over a communication channel, which may comprise without limitation a hypertext transfer protocol channel, a secure transport layer channel, a near-field communication channel, a Bluetooth channel, a wired communication channel, or any combination thereof. The verifier communicates with the Bitcoin blockchain through any source providing Bitcoin blockchain data, including without limitation a Bitcoin node operated by the verifier, a Bitcoin node operated by a third party, an indexing service, or a public block explorer. The verifier may cache Bitcoin blockchain data and may apply a confirmation threshold to determine when a detected spend event is treated as a finalized revocation condition.

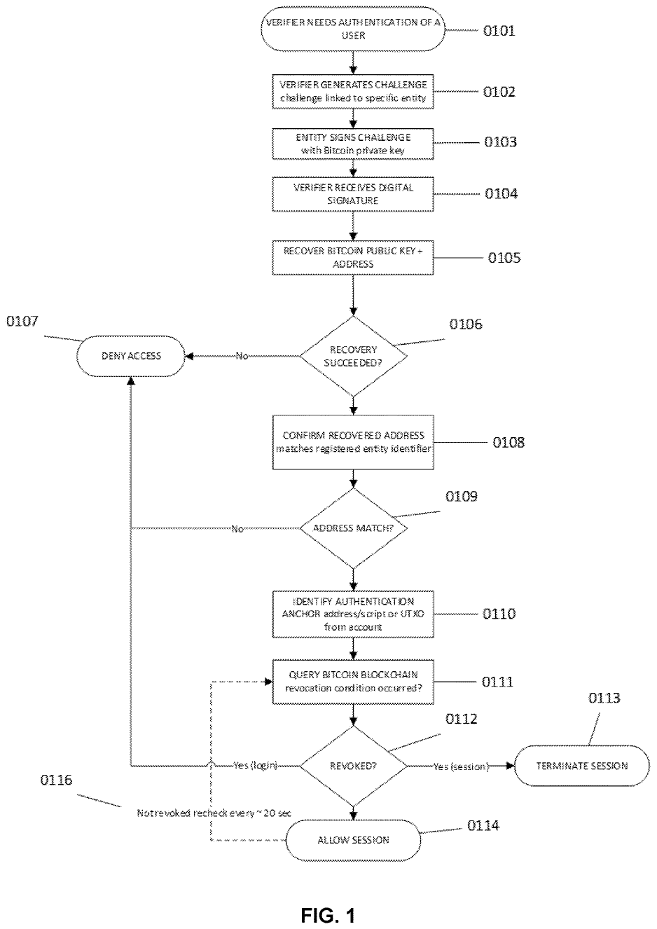

Referring now to FIG. 1, there is shown an authentication and access control method performed by a verifier in accordance with an embodiment of the present invention. The method depicted in FIG. 1 includes three fail-closed decision points and a continuous session monitoring loop that periodically re-evaluates the revocation condition while an authenticated session remains active.

The method begins at element 0101, which represents the initiating condition in which the verifier requires authentication of an entity prior to granting access to a protected resource. The protected resource may comprise, without limitation, a digital application, an account, a system, a network, a device, an encrypted data store, a digital service, a lock, a safe, a vehicle ignition, a door, a secured enclosure, or a secured environment. The entity at element 0101 has not yet provided any authentication material to the verifier; the verifier proceeds to element 0102 to generate a challenge message.

At element 0102, the verifier generates a challenge message. The challenge message is associated with an entity identifier specific to the authenticating entity at the time of generation, binding the challenge to a specific account or identity context. In one embodiment, the challenge message comprises a structured payload including one or more of a relying-party identifier, an action identifier, a nonce, an expiration value, a client identifier, and a context value, and the structured payload is serialized prior to signing in a canonical form. In other embodiments, the challenge message may comprise a simple alphanumeric string. The challenge message is transmitted from the verifier to the entity over a communication channel.

At element 0103, the entity generates a digital signature over the challenge message using a Bitcoin private key. The Bitcoin private key corresponds to a Bitcoin public key associated with a Bitcoin address or locking script. In a preferred embodiment, the digital signature is generated in accordance with the Bitcoin Signed Message format under BIP-137, in which the signature comprises a recovery byte and an ECDSA signature over the secp256k1 curve, and from which the corresponding Bitcoin public key may be mathematically recovered. In further embodiments, the digital signature is generated in accordance with BIP-322 or comprises a Schnorr signature under BIP-340 corresponding to a Taproot output. The entity transmits the digital signature and an authentication anchor identifier to the verifier without transmitting the Bitcoin public key. The authentication anchor identifier may comprise the Bitcoin address, a locking script identifier, or a transaction identifier and an output index identifying a designated unspent transaction output.

At element 0104, the verifier receives the digital signature over the challenge message from the entity. The verifier also receives, where applicable, the entity identifier and the authentication anchor identifier at this stage. In an alternative embodiment described further below in connection with the registry-based identification embodiment, the verifier receives only the digital signature without an entity identifier or authentication anchor identifier and identifies the authentication anchor through the recovery operation of element 0105 followed by a registry lookup.

At element 0105, the verifier recovers the Bitcoin public key and the corresponding Bitcoin address mathematically from the digital signature, without the Bitcoin public key having been transmitted by the entity. In a preferred embodiment using the Bitcoin Signed Message format under BIP-137, the digital signature comprises a recovery byte that, in combination with the ECDSA signature components and the challenge message, permits unique reconstruction of the public key on the secp256k1 elliptic curve. The Bitcoin address is then derived from the recovered public key by applying a defined hash function and address encoding. In embodiments employing Schnorr signatures under BIP-340, the corresponding Bitcoin public key may be conveyed as part of the signature payload or recovered through equivalent reconstruction techniques compatible with the signature scheme. In all embodiments, the recovery operation of element 0105 is performed without the verifier transmitting any private key material and without the Bitcoin public key having been previously communicated by the entity in the present authentication exchange.

Element 0106 is a first fail-closed decision point determining whether the cryptographic recovery operation at element 0105 produced a valid result. If recovery fails because the digital signature is malformed, uses an invalid format, or is not a valid signature over the challenge message under the relevant signature scheme, the No path is taken and the method proceeds to element 0107 (Deny Access). If recovery succeeds, the Yes path is taken and the method proceeds to element 0108.

Element 0107 is the denial terminal reached when any of the three fail-closed decision points (elements 0106, 0109, and 0112 at login time) returns a negative result. Access is denied and no further authentication steps are performed. Denial at element 0107 is legally distinct from session termination at element 0113, which is reached only during continuous session monitoring after authorization has been granted.

At element 0108, the verifier compares the Bitcoin address recovered at element 0105 to the registered entity identifier associated with the authentication account. This comparison verifies that the digital signature was produced by the private key corresponding to the registered Bitcoin address and not by a different key.

Element 0109 is a second fail-closed decision point determining whether the recovered Bitcoin address matches the registered entity identifier. If the addresses do not match, indicating that the digital signature was produced by a private key other than the one registered to this entity, the No path is taken and the method proceeds to element 0107 (Deny Access). If the addresses match, the Yes path is taken and the method proceeds to element 0110.

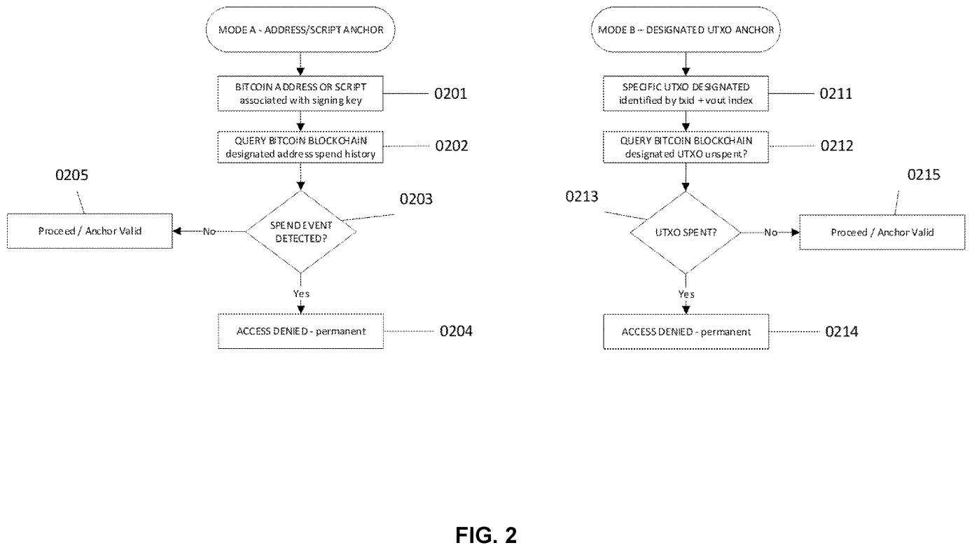

At element 0110, the verifier determines the authentication anchor associated with the authenticated entity account. The authentication anchor comprises at least one of (i) a Bitcoin address or locking script, corresponding to the address-based anchor mode described further in connection with FIG. 2, and (ii) a designated unspent transaction output identified by a transaction identifier and an output index, corresponding to the UTXO-based anchor mode described further in connection with FIG. 2.

At element 0111, the verifier queries Bitcoin blockchain data to determine whether a revocation condition associated with the authentication anchor has occurred. For an address-based anchor, the verifier checks whether a spend event associated with the Bitcoin address or locking script has been recorded on the Bitcoin blockchain. For a UTXO-based anchor, the verifier checks whether the designated unspent transaction output remains unspent. The Bitcoin blockchain data may be obtained from a Bitcoin node, an indexing service, a public block explorer, or any combination thereof. In some embodiments, the verifier applies a configurable number of required on-chain confirmations before treating a detected spend event as a finalized revocation condition; the configurable number may range, by way of non-limiting example, from zero confirmations through six or more confirmations depending on the security profile of the protected resource.

Element 0112 is a third fail-closed decision point determining whether the revocation condition determined at element 0111 has occurred. Element 0112 is reached both during the initial authentication flow and during continuous session monitoring via element 0116. When element 0112 is reached during the initial authentication flow and the revocation condition has occurred, the Yes (login) path is taken and the method proceeds to element 0107 (Deny Access). When element 0112 is reached during continuous session monitoring and the revocation condition has occurred during an active session, the Yes (session) path is taken and the method proceeds to element 0113 (Terminate Session). When the revocation condition has not occurred, the No path is taken and the method proceeds to element 0114 (Allow Session) or returns to monitoring as appropriate.

At element 0114, access is authorized because all three fail-closed conditions have been satisfied: the digital signature is valid (elements 0105-0106), the recovered Bitcoin address matches the registered entity identifier (elements 0108-0109), and the authentication anchor is not revoked (elements 0111-0112). Access authorization at element 0114 may comprise establishing an authenticated session having a defined session duration, issuing a session token, granting a one-time authorization for a specific action, or performing any other authorization operation appropriate to the protected resource.

Element 0116 represents the continuous monitoring loop that periodically re-queries the Bitcoin blockchain during an active authenticated session. In a preferred embodiment, the revocation condition is re-determined at intervals of approximately twenty seconds during the active session; in further embodiments, the interval may be configured from sub-second to multi-minute periods depending on application requirements. At each iteration of the continuous monitoring loop, control returns from element 0114 (Allow Session) to element 0111 (Query Bitcoin blockchain) for re-evaluation of the revocation condition. The continuous monitoring loop continues for the duration of the active session.

Element 0113 is the session termination terminal reached when the continuous monitoring loop at element 0116 detects that the revocation condition has occurred during an active session. Session termination at element 0113 is legally distinct from access denial at element 0107: element 0107 represents denial of an attempted authentication, while element 0113 represents revocation of authority during an authenticated session that was previously granted. In some embodiments, session termination at element 0113 further comprises invalidation of any session tokens, revocation of any temporary credentials, and notification of one or more downstream services that the session has been terminated.

Referring now to FIG. 2, there is shown two embodiments of the authentication anchor of the present invention. In a first embodiment, shown in the left panel of FIG. 2, identity and authority are anchored to a Bitcoin address or locking script (referred to herein as Mode A). In a second embodiment, shown in the right panel of FIG. 2, identity and authority are anchored to a specific designated unspent transaction output identified by a transaction identifier and an output index (referred to herein as Mode B). In both embodiments, the entity holding the private key corresponding to the anchor retains sole control over the timing of revocation by choosing when to execute the spend transaction that triggers it.

In the first embodiment shown in the left panel of FIG. 2, element 0201 represents the authentication anchor comprising a Bitcoin address or locking script associated with a signing key held by the authenticating entity. The anchor at element 0201 may be any Bitcoin address or locking script for which the entity holds the corresponding private key. In a particular sub-embodiment of element 0201 referred to herein as a wallet-based anchor, the Bitcoin address has zero outgoing spend transactions recorded on the Bitcoin blockchain at the time of authentication, and any subsequent outgoing spend transaction associated with the address triggers permanent and automatic revocation. The anchor at element 0201 may receive funds and accumulate unspent transaction outputs without affecting its unrevoked status; revocation is triggered only by an outgoing spend.

Element 0202 in the left panel of FIG. 2 represents the blockchain query step for the address-based anchor embodiment. At element 0202, the verifier queries Bitcoin blockchain data to determine whether a spend event associated with the designated Bitcoin address or locking script has been recorded on the Bitcoin blockchain. The query at element 0202 may, in alternative embodiments, be performed against a Bitcoin node, an indexing service, a public block explorer, or any combination thereof, and may include the application of a confirmation threshold as described in connection with element 0111 of FIG. 1.

Element 0203 in the left panel of FIG. 2 represents the revocation decision point for the address-based anchor embodiment. If a spend event associated with the anchor has been detected at element 0202, the Yes path is taken and access is permanently denied at element 0204. If no spend event has been detected, the No path is taken and the authentication flow proceeds to element 0205, indicating that the anchor remains valid.

Element 0204 in the left panel of FIG. 2 represents the permanent access denial terminal for the address-based anchor embodiment. Once a spend event is detected, all subsequent authentication attempts using that anchor are denied regardless of signature validity. The denial at element 0204 is irrevocable and does not require any further administrative or coordinating action; it is enforced automatically by the publicly verifiable state of the Bitcoin blockchain.

Element 0205 in the left panel of FIG. 2 represents the proceed terminal for the address-based anchor embodiment, reached when no spend event has been detected at element 0203. When element 0205 is reached, the authentication anchor is determined to be unrevoked and the authentication flow continues. In one embodiment, multiple unspent transaction outputs received at the same address may independently serve as authentication anchors for separate accounts, services, or delegation hierarchies, each independently revocable by spending the corresponding output, as further described in connection with the multiple independent anchor embodiment described below.

In the second embodiment shown in the right panel of FIG. 2, element 0211 represents the authentication anchor comprising a specific designated unspent transaction output identified by its transaction identifier and output index. Unlike the address-based embodiment of element 0201, in which any outgoing spend from the address triggers revocation, in the UTXO-based embodiment of element 0211 only the spending of the specifically designated output triggers revocation. The entity may hold other unspent transaction outputs at the same address without affecting the unrevoked status of the designated output.

Element 0212 in the right panel of FIG. 2 represents the blockchain query step for the UTXO-based anchor embodiment. At element 0212, the verifier queries Bitcoin blockchain data to determine whether the designated unspent transaction output, identified by transaction identifier and output index, remains unspent.

Element 0213 in the right panel of FIG. 2 represents the revocation decision point for the UTXO-based anchor embodiment. If the designated unspent transaction output has been spent, the Yes path is taken and access is permanently denied at element 0214. If the designated unspent transaction output remains unspent, the No path is taken and the authentication flow proceeds to element 0215, indicating that the anchor remains valid.

Element 0214 in the right panel of FIG. 2 represents the permanent access denial terminal for the UTXO-based anchor embodiment. Spending the designated unspent transaction output causes irreversible access denial for that anchor. As with the address-based embodiment, this denial requires no centralized coordination, no revocation list distribution, and no administrative action.

Element 0215 in the right panel of FIG. 2 represents the proceed terminal for the UTXO-based anchor embodiment, reached when the designated unspent transaction output remains unspent at element 0213. When element 0215 is reached, the authentication anchor is determined to be unrevoked and the authentication flow continues.

In both embodiments illustrated in FIG. 2, the entity holding the private key corresponding to the anchor retains sole control over the timing of revocation by choosing when to execute the spend transaction that triggers it. The revocation event is a deliberate, irreversible act that simultaneously and automatically denies all subsequent authentication attempts using the revoked anchor. No third party—including any verifier, certificate authority, identity provider, or attestor—is capable of triggering or reversing revocation in either embodiment.

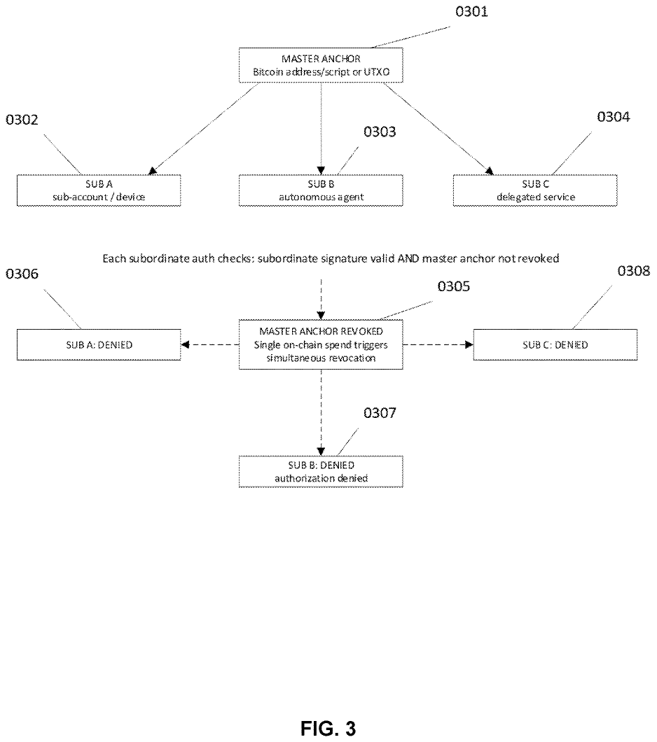

Referring now to FIG. 3, there is shown a hierarchical delegation and revocation embodiment of the present invention in which a master authentication anchor authorizes one or more subordinate credentials. The master authentication anchor is shown at the top of the hierarchy in FIG. 3, with three subordinate credentials (elements 0302, 0303, and 0304) authorized by the master. The hierarchical delegation and revocation embodiment of FIG. 3 enables a single on-chain spend transaction affecting the master authentication anchor to simultaneously and irreversibly revoke authorization for all subordinate credentials authorized by the master.

Element 0301 in FIG. 3 represents the master authentication anchor, which may be either an address-based anchor as described in connection with element 0201 of FIG. 2 or a designated unspent transaction output anchor as described in connection with element 0211 of FIG. 2. The master authentication anchor at element 0301 is associated with a master private key held by a principal entity. The principal entity may be a human user, an institutional actor, a hardware device, or any other party capable of holding and using a Bitcoin private key.

Elements 0302, 0303, and 0304 in FIG. 3 represent subordinate credentials authorized by the master authentication anchor at element 0301. Subordinate credentials may be associated with sub-accounts, devices, delegated users, autonomous software agents (including, without limitation, large language model based agents), or any other entity to which authority is delegated. Each subordinate credential is cryptographically linked to the master authentication anchor by a delegation statement signed by the master private key. By way of non-limiting example, element 0302 may represent a subordinate credential authorizing a sub-account or device, element 0303 may represent a subordinate credential authorizing an autonomous software agent, and element 0304 may represent a subordinate credential authorizing a delegated service or third-party integration.

During authentication of a subordinate credential, the verifier checks (i) the validity of the subordinate signature over the challenge message, (ii) the cryptographic linkage between the subordinate credential and the master authentication anchor, and (iii) the revocation condition of the master authentication anchor as determined from Bitcoin blockchain data. Authorization of access for a subordinate credential is granted only when all three checks succeed; if the master authentication anchor has been revoked, authorization is denied for the subordinate credential regardless of the validity of the subordinate signature.

Element 0305 in FIG. 3 represents the revocation event in which the master authentication anchor is spent. This may be accomplished by the principal entity executing a single on-chain spend transaction affecting the master authentication anchor—either spending the designated unspent transaction output (for a UTXO-based master anchor) or initiating any outgoing spend from the address (for an address-based master anchor). The revocation event at element 0305 is a single, deliberate, irreversible action under the sole control of the principal entity.

Elements 0306, 0307, and 0308 in FIG. 3 represent the simultaneous denial of authorization for all subordinate credentials upon detection of the master authentication anchor revocation event at element 0305. All subordinate credentials are denied simultaneously and without requiring distribution of any per-subordinate revocation messages, communication with any third party, or any administrative action by the principal entity beyond the original spend transaction. The verifier, upon next querying Bitcoin blockchain data and detecting the spend event at element 0305, will deny authentication for all subordinate credentials linked to the revoked master.

The hierarchical delegation and revocation mechanism illustrated in FIG. 3 is particularly applicable to scenarios in which a principal entity delegates authority to autonomous software agents, large language model based agents, or automated processes. By spending the master authentication anchor, the principal entity immediately and irrevocably terminates the authority of all such delegated agents simultaneously. This provides a single, technically enforced kill switch over distributed agent populations without reliance on any centralized administrative actor.

### Optional Embodiments and Variations

In one embodiment, eligibility for authentication requires the authentication anchor to satisfy a minimum funding condition—for example, having received at least one satoshi—prior to authorizing access. This funding threshold imposes a lightweight cost on credential creation and deters mass identity creation attacks. In an alternative embodiment, the authentication anchor may be unfunded at the time of registration, with the unrevoked status being established by the absence of any outgoing spend transaction; in such an alternative embodiment, the receipt of funds at the address followed by a spend of those funds may itself serve as the revocation event.

In an advanced embodiment, an entity may rotate an authentication anchor by signing a transition message linking the current authentication anchor to a future authentication anchor prior to triggering revocation of the current authentication anchor. The transition message comprises a digital signature, produced by the private key associated with the current authentication anchor, over a payload identifying the future authentication anchor and a transition timestamp or block height. The verifier accepts the transition as a verifiable continuity event and updates the authentication anchor associated with the entity to the future authentication anchor. Anchor rotation in accordance with this embodiment enables credential rotation without loss of service, while maintaining a verifiable continuity path between the prior and current credentials.

In one embodiment, the verifier applies a configurable number of required on-chain confirmations before treating a detected spend event as a finalized revocation condition. This confirmation threshold allows verifiers to balance security against speed depending on the specific application context. By way of non-limiting example, a low-value digital service may treat zero confirmations as sufficient, while a high-value physical access system may require six or more confirmations.

In one embodiment, subordinate credentials may include time-based restrictions wherein authorization automatically expires after a specified block height or timestamp, independent of whether the master authentication anchor has been revoked. In another embodiment, the entity may store the private key for the authentication anchor in a hardware wallet, a hardware security module, a smart card, a secure enclave of a general-purpose processor, or any other tamper-resistant device.

In some embodiments, the system may be used in conjunction with a public distributed ledger other than the Bitcoin blockchain. In such alternative embodiments, the authentication anchor revocation condition is determined from the transaction state of the alternative public distributed ledger. The Bitcoin blockchain is the preferred public distributed ledger for the present invention due to its immutability, decentralization, and public verifiability, but the methods and systems described herein may be applied to alternative public distributed ledgers supporting analogous transaction primitives.

In one embodiment, a single principal entity registers a plurality of independent authentication anchors, each authentication anchor of the plurality being independently associated with a distinct service, account, resource, or delegation hierarchy. The revocation condition occurring for one authentication anchor of the plurality does not affect the revocation status of any other authentication anchor of the plurality. This embodiment enables the principal entity to compartmentalize authority across separate domains, services, or use cases—for example, by holding a first authentication anchor for a financial service, a second authentication anchor for a communication service, and a third authentication anchor for a physical access system—each of which may be independently revoked without affecting authority granted under the others.

In one embodiment, the authentication anchor comprises a multi-signature locking script requiring a threshold number M of valid digital signatures from N distinct Bitcoin private keys (where M is less than or equal to N) to authorize access. In this embodiment, the verifier confirms that the required threshold of valid signatures over the challenge message has been received before authorizing access, and revocation occurs upon detection of a spend event associated with the multi-signature address or locking script. This embodiment is particularly applicable where authority over a resource is shared among multiple principals—for example, where access requires consent of two or more board members, or where a hardware-software signing combination is required to authorize access. The multi-signature locking script may be implemented in accordance with any multi-signature primitive supported by the Bitcoin protocol, including without limitation legacy bare multi-signature scripts, pay-to-script-hash multi-signature scripts, and Taproot multi-signature constructions under BIP-340 and BIP-342.

In one embodiment, a single principal entity manages a plurality of independent delegation hierarchies simultaneously, each delegation hierarchy of the plurality comprising a distinct master authentication anchor and one or more associated subordinate credentials. This embodiment enables the principal entity to compartmentalize authority across separate domains, services, or use cases, each independently revocable by spending the corresponding master authentication anchor without affecting authority granted under the master authentication anchors of other delegation hierarchies.

In one embodiment, an entity pre-registers one or more recovery anchors at account creation. Each recovery anchor comprises a Bitcoin address, locking script, or designated unspent transaction output separate from the primary authentication anchor, for which the entity holds the corresponding private key. In the event of compromise of the primary anchor signing key, the entity may use a pre-registered recovery anchor to authorize a transition to a new primary authentication anchor without requiring access to the compromised key. The verifier accepts a recovery anchor transition upon receiving a valid digital signature, produced by the private key associated with the recovery anchor, over a payload identifying the new primary authentication anchor. In some embodiments, the verifier may require multiple recovery anchors to act jointly to authorize a recovery transition, providing an analog to multi-party recovery without reliance on a centralized recovery service.

In one embodiment, the entity transmits only the digital signature to the verifier without transmitting an entity identifier or an authentication anchor identifier. The verifier recovers the Bitcoin address from the digital signature at element 0105 of FIG. 1 and determines the associated authentication anchor by querying a registry of registered Bitcoin addresses against the recovered Bitcoin address. If the recovered Bitcoin address matches a registered authentication anchor in the registry, authentication proceeds to the revocation condition check at element 0111 of FIG. 1. If no matching Bitcoin address is found in the registry, access is denied. This embodiment requires no advance disclosure of identity by the authenticating entity in the present authentication exchange—identity is established solely through the cryptographic act of signing, with the recovered Bitcoin address serving as the complete entity identifier.

In one embodiment, the verifier signs the challenge message using a Bitcoin private key associated with a verifier authentication anchor prior to transmitting the challenge message to the entity. The entity verifies the verifier's digital signature over the challenge message and, optionally, determines from Bitcoin blockchain data that the verifier authentication anchor is unrevoked before generating the entity's digital signature over the challenge message. This mutual authentication embodiment enables the entity to cryptographically confirm the legitimacy of the verifier prior to signing, providing protection against phishing and man-in-the-middle attacks. The verifier authentication anchor is subject to the same revocation mechanism as entity authentication anchors—a spent verifier authentication anchor signals to entities that the verifier is no longer authorized.

In one embodiment, the verifier holds no private key associated with the entity and stores no shared secret recoverable by the verifier in isolation. The verifier authenticates the entity using only public information comprising the digital signature received from the entity, the challenge message generated by the verifier, and Bitcoin blockchain data obtained by the verifier. This watch-only verification embodiment ensures that compromise of the verifier's storage or communication infrastructure does not yield any material capable of impersonating an entity.

In one embodiment, the entity comprises an autonomous software agent including, without limitation, a large language model based agent, a robotic process automation agent, or a multi-agent system component. The autonomous software agent is associated with a subordinate credential authorized by a master authentication anchor held by a principal entity distinct from the autonomous software agent. The principal entity, by spending the master authentication anchor, immediately and irrevocably terminates the authority of the autonomous software agent. This embodiment is particularly applicable to scenarios in which a human principal entity delegates authority to an autonomous software agent for the performance of one or more tasks and requires a technically enforceable mechanism to immediately and irrevocably withdraw that authority.

### Conclusion

The present invention provides an authentication and access control system in which authority is conditioned on cryptographic proof of control of a Bitcoin private key and on the unrevoked state of an authentication anchor as determined from Bitcoin blockchain data. The invention supports two anchor modes—an address or locking script mode and a designated unspent transaction output mode—and supports hierarchical delegation in which a master authentication anchor authorizes one or more subordinate credentials and a single on-chain spend event causes simultaneous and irreversible revocation of all subordinate credentials. Optional embodiments described herein include minimum funding requirements, configurable confirmation thresholds, anchor rotation, multiple independent anchors per principal, multi-signature anchors, registry-based identification, mutual authentication, watch-only verification, autonomous software agent delegation, and pre-registered recovery anchors.

The disclosed embodiments are illustrative, not restrictive. While specific configurations of the invention have been described in a particular manner referring to the illustrated embodiments, it is understood that the present invention can be applied to a wide variety of solutions which fit within the scope and spirit of the claims. There are many alternative ways of implementing the invention. It is to be understood that the embodiments of the invention herein described are merely illustrative of the application of the principles of the invention. Reference herein to details of the illustrated embodiments is not intended to limit the scope of the claims, which themselves recite those features regarded as essential to the invention.

What is claimed is:

1. A computer-implemented method for authenticating and controlling access, the method being performed by one or more processors of a verifier and comprising:
generating a challenge message;
receiving a digital signature over the challenge message from an entity;
recovering a Bitcoin public key and a corresponding Bitcoin address from the digital signature without the Bitcoin public key having been transmitted by the entity;
determining an authentication anchor associated with the entity, the authentication anchor comprising at least one of a Bitcoin address or locking script and a designated unspent transaction output identified by a transaction identifier and an output index;
determining, using Bitcoin blockchain data, whether a revocation condition associated with the authentication anchor has occurred; and
authorizing access when the Bitcoin public key and the corresponding Bitcoin address are successfully recovered from the digital signature and the revocation condition has not occurred.

2. The method of claim 1, wherein the authentication anchor comprises a Bitcoin address or locking script, and the revocation condition comprises detection of a spend event associated with the Bitcoin address or locking script, wherein a spend event associated with a Bitcoin address or locking script means a transaction recorded on the Bitcoin blockchain that consumes as one of its inputs an output having a locking script corresponding to the Bitcoin address or locking script.

3. The method of claim 2, wherein the authentication anchor is a Bitcoin address having zero outgoing spend transactions recorded on the Bitcoin blockchain, and the revocation condition is triggered by any outgoing spend transaction associated with said address.

4. The method of claim 1, wherein the authentication anchor comprises a designated unspent transaction output identified by a transaction identifier and an output index, and the revocation condition comprises the designated unspent transaction output being spent.

5. The method of claim 1, wherein the challenge message comprises at least one of a timestamp, a nonce, an expiration value, a relying-party identifier, an action identifier, a client identifier, and a context value, and authorizing access further comprises enforcing a freshness requirement based on the challenge message.

6. The method of claim 1, further comprising associating the challenge message with an entity identifier and verifying that the digital signature was produced by a signing key associated with the entity identifier.

7. The method of claim 1, wherein authorizing access comprises authorizing at least one action, operation, or use of a resource, the resource comprising at least one of an application, an account, a system, a network, a device, an encrypted data store, a digital service, a lock, a safe, a vehicle ignition, a door, a secured enclosure, and a secured environment.

8. The method of claim 1, further comprising transitioning from a first authentication anchor to a second authentication anchor based on a signed transition statement linking the first authentication anchor to the second authentication anchor and produced prior to a revocation condition associated with the first authentication anchor.

9. The method of claim 1, further comprising delegated authorization, wherein:
a master authentication anchor authorizes one or more subordinate credentials;
authorizing access for a subordinate credential of the one or more subordinate credentials depends on the master authentication anchor not being revoked; and
revocation of the master authentication anchor causes simultaneous denial of access for all subordinate credentials authorized by the master authentication anchor.

10. The method of claim 1, further comprising the entity maintaining a plurality of authentication anchors simultaneously, each authentication anchor of the plurality being independently associated with a distinct service, account, or resource, and wherein the revocation condition occurring for one authentication anchor of the plurality does not affect the revocation status of any other authentication anchor of the plurality.

11. The method of claim 1, wherein the authentication anchor comprises a multi-signature locking script requiring a threshold number of valid digital signatures from distinct Bitcoin private keys to authorize access, and authorizing access further comprises receiving and verifying the threshold number of valid digital signatures over the challenge message.

12. The method of claim 1, wherein the digital signature comprises at least one of (i) a Bitcoin Signed Message under BIP-137 or BIP-322 from which the Bitcoin public key is recovered by an elliptic curve digital signature algorithm public-key recovery operation over the secp256k1 curve, and (ii) a Schnorr signature under BIP-340 corresponding to a Taproot output address.

13. The method of claim 1, wherein the verifier holds no private key associated with the entity and authenticates the entity using only public information comprising the digital signature, the challenge message, and Bitcoin blockchain data.

14. The method of claim 9, wherein the entity comprises an autonomous software agent including a large language model based agent, the master authentication anchor authorizing the autonomous software agent is held by a principal entity distinct from the autonomous software agent, and revocation of the master authentication anchor by the principal entity causes denial of access for the autonomous software agent.

15. The method of claim 1, further comprising periodically re-determining, during an active session established upon authorization, whether the revocation condition associated with the authentication anchor has occurred, and terminating the active session upon detecting that the revocation condition has occurred.

16. The method of claim 1, wherein the digital signature is received from the entity without an entity identifier or an authentication anchor identifier being transmitted by the entity, and determining the authentication anchor comprises querying a registry of registered Bitcoin addresses against the recovered Bitcoin address and identifying the authentication anchor associated with a matching registered Bitcoin address.

17. The method of claim 1, further comprising, prior to receiving the digital signature, signing the challenge message by the verifier using a verifier Bitcoin private key associated with a verifier authentication anchor and transmitting the signed challenge message to the entity.

18. The method of claim 1, further comprising pre-registering, by the entity, one or more recovery anchors at account creation, each recovery anchor comprising a Bitcoin address, locking script, or designated unspent transaction output separate from a primary authentication anchor, and authorizing, in response to a signed recovery request from one of the recovery anchors, a transition from the primary authentication anchor to a new authentication anchor.

19. A system for authenticating and controlling access, the system comprising:
one or more processors; and
one or more non-transitory computer-readable media storing instructions that, when executed by the one or more processors, cause the system to perform operations comprising:
generating a challenge message;
receiving a digital signature over the challenge message from an entity;
recovering a Bitcoin public key and a corresponding Bitcoin address from the digital signature without the Bitcoin public key having been transmitted by the entity;
determining an authentication anchor associated with the entity, the authentication anchor comprising at least one of a Bitcoin address or locking script and a designated unspent transaction output identified by a transaction identifier and an output index;
determining, using Bitcoin blockchain data, whether a revocation condition associated with the authentication anchor has occurred; and
authorizing access when the Bitcoin public key and the corresponding Bitcoin address are successfully recovered from the digital signature and the revocation condition has not occurred.

20. A non-transitory computer-readable medium storing instructions that, when executed by one or more processors of a verifier, cause the one or more processors to perform operations comprising:
generating a challenge message;
receiving a digital signature over the challenge message from an entity;
recovering a Bitcoin public key and a corresponding Bitcoin address from the digital signature without the Bitcoin public key having been transmitted by the entity;
determining an authentication anchor associated with the entity, the authentication anchor comprising at least one of a Bitcoin address or locking script and a designated unspent transaction output identified by a transaction identifier and an output index;
determining, using Bitcoin blockchain data, whether a revocation condition associated with the authentication anchor has occurred; and
authorizing access when the Bitcoin public key and the corresponding Bitcoin address are successfully recovered from the digital signature and the revocation condition has not occurred.

21. A computer-implemented method for proving identity to an authentication system, the method being performed by one or more processors of an entity and comprising:
generating a digital signature over a challenge message using a Bitcoin private key, wherein the Bitcoin private key corresponds to a Bitcoin public key associated with a Bitcoin address or locking script;
transmitting the digital signature to a verifier without transmitting the Bitcoin public key; and
receiving an authorization decision from the verifier based on recovery of the Bitcoin public key and a corresponding Bitcoin address from the digital signature and an unrevoked condition of an authentication anchor associated with the entity as determined from Bitcoin blockchain data.
